(19) United States
(12) Patent Application Publication
(10) Pub. No.: US 2012/0128103 A1
(43) Pub. Date: May 24, 2012

(54) SYMBOL RATE DETECTOR AND RECEIVER

(75) Inventor: Shigeru SOGA, Hyogo (JP)

(73) Assignee: Panasonic Corporation, Osaka (JP)

(21) Appl. No.: 13/361,257

(22) Filed: Jan. 30, 2012

Related U.S. Application Data
(63) Continuation of application No. PCT/JP2010/004793, filed on Jul. 28, 2010.

(30) Foreign Application Priority Data
Jul. 30, 2009 (JP) 2009-178180

(51) Int. Cl. H04L 27/06

(52) U.S. Cl. 375/340

(57) ABSTRACT

The symbol rate detector includes a nonlinear processing section configured to perform nonlinear processing on a digitally modulated signal, and to output a processed signal, and a phase-locked loop being in synchronization with the processed signal. The phase-locked loop includes an oscillator configured to generate a signal with a frequency corresponding to a detected symbol rate, a complex multiplier configured to multiply the processed signal by the signal generated by the oscillator, and to output a multiplication result, and a loop filter configured to smooth the multiplication result, and to output the smoothed multiplication result as the detected symbol rate.

### CROSS-REFERENCE TO RELATED APPLICATION

This is a continuation of PCT International Application PCT/JP2010/004793 filed on Jul. 28, 2010, which claims priority to Japanese Patent Application No. 2009-178180 filed on Jul. 30, 2009. The disclosures of these applications including the specifications, the drawings, and the claims are hereby incorporated by reference in their entirety.

### BACKGROUND

The present disclosure relates to techniques for detecting symbol rates of digitally modulated signals.

In recent years, digital television broadcasting transmitting audio signals and video signals using digital modulation has been in practical use. For example, broadcasting based on digital video broadcasting-cable (DVB-C), which is a cable television system, is performed around the world. Since a bandwidth of each channel of television broadcasting differs from country to country, a symbol rate determining a bandwidth is defined as being in the range from 4 to 7.2 Mbaud. If a receiver has the function of automatically detecting a symbol rate, the receiver can be commonly used in many countries, thereby reducing development costs.

Automatic detection of a symbol rate requires a small circuit scale and high precision rate detection in a short time. Performing nonlinear processing and fast Fourier transform (FFT) on a received signal to detect as a symbol rate, a frequency of a component having a peak from a frequency domain signal after the FFT is known as a method of automatically detecting a symbol rate (see, for example, U.S. Pat. No. 7,376,204).

### SUMMARY

However, in the technique shown in U.S. Pat. No. 7,376,204, the number of samples subject to the FFT needs to be increased to improve resolution of symbol rate detection. Thus, the memory capacity of an FFT circuit needs to be large, thereby increasing the circuit scale. The FFT is required to be performed with respect to all frequency domains ranging from frequency 0 to a sampling frequency at once. Since components out of the range of the symbol rate to be detected are also subject to the operation, a long time is required to detect the symbol rate.

It is an objective of the present disclosure to reduce a circuit scale, and detect a symbol rate of a digitally modulated signal in a short time.

A symbol rate detector according to the present disclosure includes a nonlinear processing section configured to perform nonlinear processing on a digitally modulated signal, and to output a processed signal; and a phase-locked loop being in phase synchronization with the processed signal. The phase-locked loop includes an oscillator configured to generate a signal with a frequency corresponding to a detected symbol rate, a complex multiplier configured to multiply the processed signal by the signal generated by the oscillator, and to output a multiplication result, and a loop filter configured to smooth the multiplication result, and to output the smoothed multiplication result as the detected symbol rate.

According to the symbol rate detector, the phase-locked loop is synchronized with the processed signal, thereby detecting the symbol rate of the digitally modulated signal without using FFT.

A receiver according to the present disclosure is for receiving a digitally modulated signal. The receiver includes a symbol rate detector configured to detect a symbol rate of the digitally modulated signal from the digitally modulated signal, and a variable-bandwidth filter configured to allow a component of the digitally modulated signal to pass, where the component is in a frequency range corresponding to the symbol rate detected by the symbol rate detector. The symbol rate detector includes a nonlinear processing section configured to perform nonlinear processing on the digitally modulated signal, and to output a processed signal, and a phase-locked loop being in synchronization with the processed signal. The phase-locked loop includes an oscillator configured to generate a signal with a frequency corresponding to the detected symbol rate, a complex multiplier configured to multiply the processed signal by the signal generated by the oscillator, and to output a multiplication result, and a loop filter configured to smooth the multiplication result, and to output the smoothed multiplication result as the detected symbol rate.

According to the present disclosure, since a symbol rate is detected without performing FFT, an increase in a circuit scale can be mitigated and the symbol rate can be detected in a short time even when the detection precision is improved.

### BRIEF DESCRIPTION OF THE DRAWINGS

FIG. 1 is a block diagram illustrating an example configuration of a receiver according to an embodiment of the present disclosure.

FIG. 2 is a block diagram illustrating an example configuration of a symbol rate detector of FIG. 1.

FIG. 3A is a schematic view illustrating a spectrum of a baseband signal which is input to a nonlinear processing section of FIG. 1.

FIG. 3B is a schematic view illustrating a spectrum of a signal after processing by the nonlinear processing section.

FIG. 3C is a schematic view illustrating a spectrum of an output signal of a DC canceller of FIG. 1.

FIG. 3D is a schematic view illustrating a spectrum of an output signal of a complex multiplier, of which frequency is shifted by −Fsym.

FIG. 3E is a schematic view illustrating a spectrum of an output signal of an LPF in a phase-locked loop.

FIG. 4 is a graph illustrating a phase-error evaluation function of an output signal of an LPF in a phase-locked loop of FIG. 2.

FIG. 5 is a graph illustrating examples of a detected symbol rate and a swept frequency.

### DETAILED DESCRIPTION

An embodiment of the present disclosure will be described hereinafter with reference to the drawings.

Functional blocks in this specification are typically implemented in hardware. For example, the functional blocks can be formed on a semiconductor substrate as part of an integrated circuit (IC). The IC includes a large-scale integrated circuit (LSI), an application-specific integrated circuit (ASIC), a gate array, a field programmable gate array (FPGA), etc. Alternatively, all or part of the functional blocks may be implemented in software. For example, such functional blocks may be implemented in a program executing on a processor. In other words, the functional blocks described in this specification may be implemented in hardware, software, and a preferable combination of hardware and software.

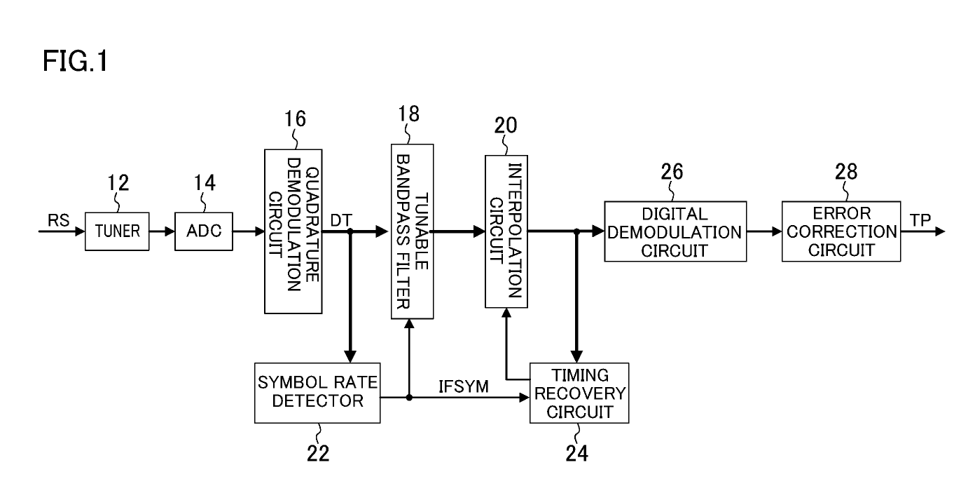

FIG. 1 is a block diagram illustrating an example configuration of a receiver according to an embodiment of the present disclosure. The receiver of FIG. 1 includes a tuner 12, an analog-to-digital (AD) converter (ADC) 14, a quadrature demodulation circuit 16, a variable-bandwidth filter 18, an interpolation circuit 20, a symbol rate detector 22, a timing recovery circuit 24, a digital demodulation circuit 26, and an error correction circuit 28. In FIG. 1 and the subsequent block diagrams, the thick line denotes a complex signal.

A received signal RS, which is a digitally modulated signal, is supplied to the tuner 12. The received signal RS is a radio frequency (RF) signal supplied from an antenna or a cable of cable television broadcasting. The tuner 12 extracts a signal of a desired channel from the received signal RS according to station selection information, and outputs the extracted signal to the ADC 14 as an intermediate frequency band (IF) signal. The ADC 14 converts the signal output from the tuner to a digital signal, and outputs the digital signal. The quadrature demodulation circuit 16 performs frequency correction on a signal output from the ADC 14 based on a carrier frequency error detected by the digital demodulation circuit 26. The quadrature demodulation circuit 16 further performs quadrature demodulation and outputs the generated baseband signal DT to the variable-bandwidth filter 18 and the symbol rate detector 22. The baseband signal DT is a complex signal.

The symbol rate detector 22 detects a symbol rate of the baseband signal DT from the baseband signal DT, and outputs the result to the variable-bandwidth filter 18 and the timing recovery circuit 24 as a detected symbol rate IFSYM. The variable-bandwidth filter 18 allows a component of the baseband signal DT to pass, where the component is in a frequency range corresponding to the detected symbol rate IFSYM. At this time, the variable-bandwidth filter 18 outputs a signal with reduced unnecessary harmonic components out of the frequency range.

The interpolation circuit 20 interpolates an output from the variable-bandwidth filter 18 based on a timing signal output from the timing recovery circuit 24, and outputs a baseband signal which is free from intersymbol interference, i.e., of which symbol can be identified. The timing recovery circuit 24 generates the timing signal using the detected symbol rate IFSYM and the baseband signal output from the interpolation circuit 20 to avoid intersymbol interference in the baseband signal output from the interpolation circuit 20, and outputs the timing signal to the interpolation circuit 20.

The digital demodulation circuit 26 detects a frequency error from a baseband signal output from the interpolation circuit 20, and outputs the frequency error to the quadrature demodulation circuit 16. The digital demodulation circuit 26 also performs waveform equalization and demodulation on the received signal RS, and outputs the obtained demodulated information to the error correction circuit 28. The waveform equalization removes distortion of the received signal RS occurring in a transmission path due to multipath propagation etc. The error correction circuit 28 corrects a bit error by performing Viterbi decoding, Reed-Solomon decoding etc., on the demodulated information, and outputs the corrected data to a video/audio decoder as transport stream packets TP.

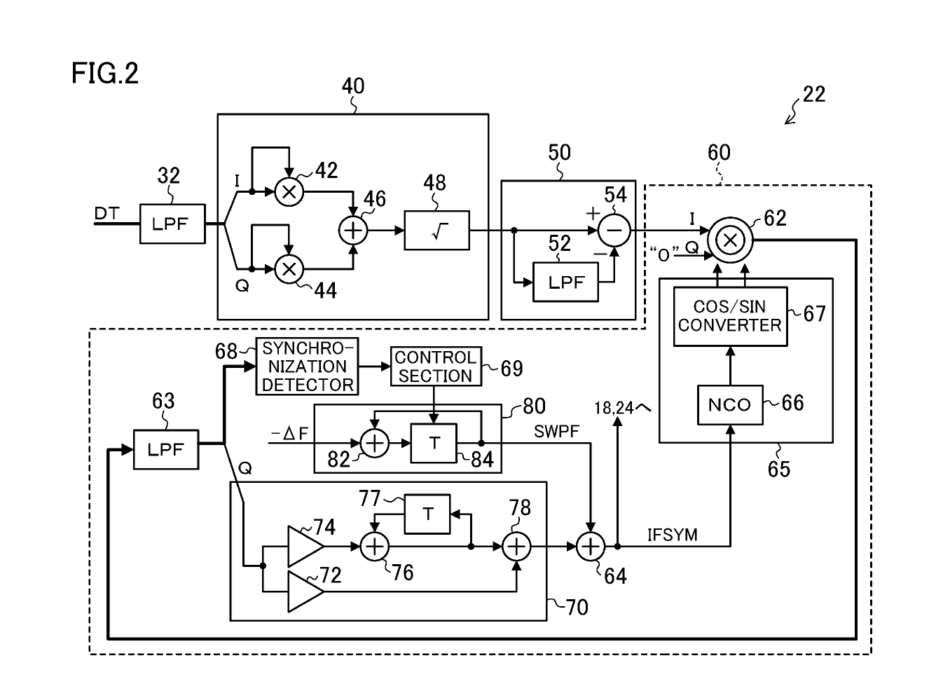

FIG. 2 is a block diagram illustrating an example configuration of the symbol rate detector 22 of FIG. 1. The symbol rate detector 22 includes a low pass filter (LPF) 32, a nonlinear processing section 40, a DC canceller 50, and a phase-locked loop 60.

The baseband signal DT, which is an output from the quadrature demodulator 16, is input to the LPF 32. The LPF 32 has frequency characteristics of allowing a digital signal having a maximum symbol rate among signals, which can be input, to pass and reducing an adjacent channel component to detect precisely the symbol rate of a desired channel without being influenced by the adjacent channel. When the tuner 12 has the great advantage of reducing the adjacent channel component, the LPF 32 may not be included.

The nonlinear processing section 40 performs nonlinear processing on the baseband signal output from the LPF 32 to generate a symbol rate component, and outputs the processed signal to the DC canceller 50. Specifically, the nonlinear processing section 40 includes multipliers 42 and 44, an adder 46, and a square-root calculator 48. An in-phase component (I signal) and a quadrature component (Q signal) of the baseband signal output from the LPF 32 are input to the multipliers 42 and 44, respectively.

The multiplier 42 multiplies the I signal by the I signal and outputs the squared I signal. The multiplier 44 multiplies the Q signal by the Q signal and outputs the squared Q signal. The adder 46 obtains and outputs the sum of the squared I signal and the squared Q signal. The square-root calculator 48 obtains and outputs a square root of the sum obtained by the adder 46. Where the I signal represents I·sin Δωt and the Q signal represents Q·cos Δωt (where Δω is an offset component of a carrier frequency, i.e., carrier offset), the obtained square root is √ (Î2+Q̂2). That is, such nonlinear processing cancels the influence of the carrier offset Δω.

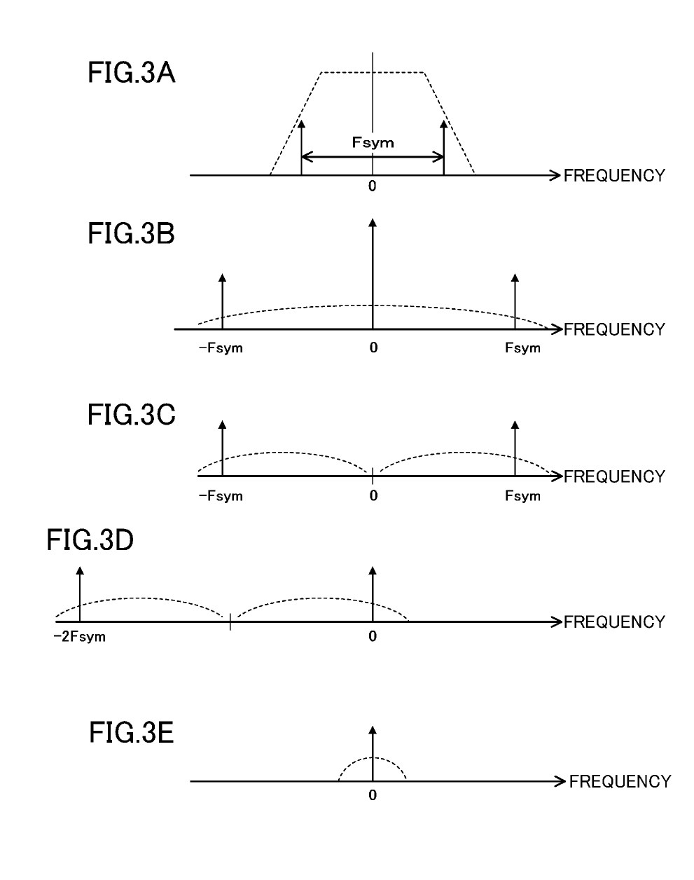

FIG. 3A is a schematic view illustrating a spectrum of the baseband signal input to the nonlinear processing section 40 of FIG. 1. The dashed line represents the spectrum of the baseband signal, and the arrows represent symbol rate components of digital modulation and appear at the ends of the spectrum band of the dashed line. FIG. 3B is a schematic view illustrating a spectrum of the processed signal obtained by the nonlinear processing section 40. As shown in FIG. 3B, the influence of the carrier offset of the symbol rate component is canceled, and energy concentrates in a DC component and the component with a frequency ±Fsym, and the other components are spread as represented by the dashed line.

The square-root calculator 48 is not essential to generate the component with the frequency ±Fsym. However, by obtaining the square root, the bit number of the result of the calculation, which has been increased by the square operation, can be halved while maintaining the resolution. This reduces the scale of the circuit performing following processing.

The DC canceller 50 outputs the processed signal obtained by the nonlinear processing section 40 to a complex multiplier 62 after reducing a direct-current component (DC component). Specifically, the DC canceller 50 includes an LPF 52 and a subtractor 54. The LPF 52 extracts the DC component from the processed baseband signal and outputs the DC component to the subtractor 54. The subtractor 54 subtracts the DC component extracted by the LPF 52 from the processed baseband signal to remove the DC component. The DC canceller 50 prevents the next phase-locked loop from erroneously coming into phase synchronization with the DC component by reducing the DC component.

FIG. 3C is a schematic view illustrating a spectrum of an output signal of the DC canceller 50 of FIG. 1. As shown in FIG. 3C, the DC component having the spectrum of FIG. 3B is reduced and then the spectrum of the frequency ±Fsym largely remains.

The phase-locked loop 60 of FIG. 2 synchronizes with the output signal of the DC canceller 50. The phase-locked loop 60 includes the complex multiplier 62, an LPF 63, an adder 64, an oscillator 65, a synchronization detector 68, a control section 69, a loop filter 70, and a sweep section 80. The oscillator 65 includes a numerically controlled oscillator (NCO) 66, and a COS/SIN converter 67.

The complex multiplier 62 performs complex multiplication of the output signal of the DC canceller 50 and a signal generated by the COS/SIN converter 67, and outputs the result to the LPF 63. For example, when the COS/SIN converter 67 outputs a component with a frequency −Fsym, the output from the DC canceller 50 is shifted by the frequency −Fsym by the complex multiplication. That is, the component with the frequency −Fsym is shifted to −2Fsym, and the component with a frequency +Fsym is shifted to the DC. FIG. 3D is a schematic view illustrating a spectrum of the output signal of the complex multiplier 62, of which frequency is shifted by −Fsym. The Q signal of the output signal of the complex multiplier 6 is equal to an output from a phase comparator in a conventional phase-locked loop.

FIG. 3E is a schematic view illustrating a spectrum of an output signal of the LPF 63 in the phase-locked loop 60. The LPF 63 allows components around the DC of the output from the complex multiplier 62 to pass, and supplies the components to the synchronization detector 68 and the loop filter 70. The LPF 63 blocks components other than those around the DC, thereby reducing the spread spectrum other than the symbol rate component.

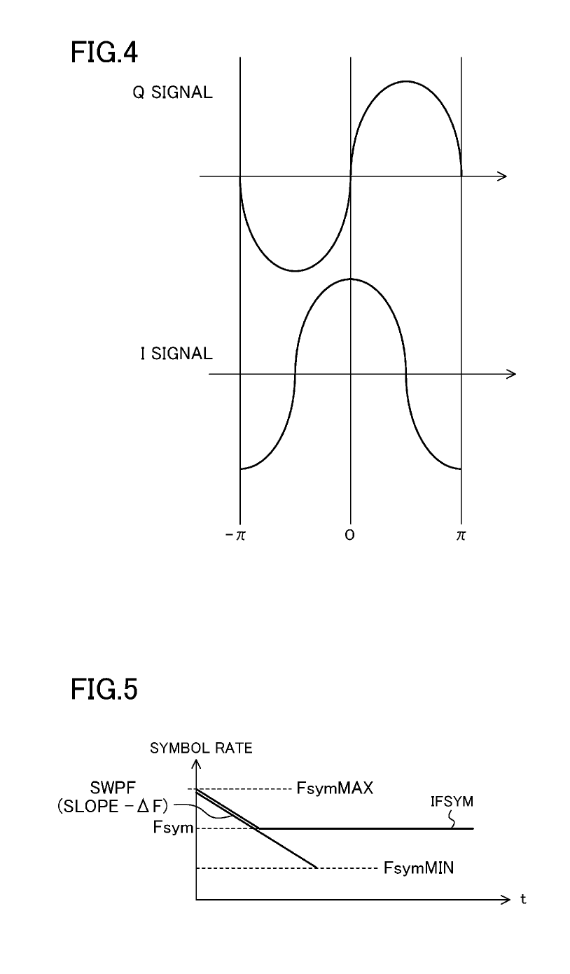

FIG. 4 is a graph illustrating a phase-error evaluation function of the output signal of the LPF 63 in the phase-locked loop 60 shown in FIG. 2. FIG. 4 shows the phase-error evaluation functions of the Q signal and the I signal of the output signal of the LPF 63 using the phase difference between input signals of the complex multiplier 62 as a parameter.

When there is no phase difference between the input signals of the complex multiplier 62, the error of the Q signal is 0. The sign of the error depends on the phase difference. When the phase difference between the input signals of the complex multiplier 62 is 0, the error of the I signal is the greatest positive value. Thus, the COS/SIN converter 67 generates a signal so that the error of the Q signal is 0, thereby bringing the phase-locked loop 60 into synchronization with the component with the frequency Fsym.

The loop filter 70 smooths the Q signal of the output from the LPF 63, and outputs the smoothed signal to the adder 64. The loop filter 70 estimates phase variations of the Q signal per unit time. Specifically, the loop filter 70 includes amplifiers 72 and 74, adders 76 and 78, and a flip-flop 77. Predetermined gains are set to the amplifiers 72 and 74. The amplifier 72 obtains a direct term from the Q signal of the output from the LPF 63, and the amplifier 74, the adder 76, and the flip-flop 77 obtains an integral term from the Q signal of the output from the LPF 63. The adder 78 adds the direct term to the integral term and outputs the sum.

The adder 64 adds an output from the sweep section 80 to an output from the loop filter 70, and outputs the addition result to the NCO 66 as the detected symbol rate IFSYM.

The detected symbol rate IFSYM is also output to the variable-bandwidth filter 18 and the timing recovery circuit 24.

The NCO 66 integrates the detected symbol rate IFSYM and outputs the integral value to the COS/SIN converter 67. Since the integral value of the NCO 66 returns to 0 each time it reaches a predetermined value, the integral value varies like a sawtooth wave. The COS/SIN converter 67 generates a COS wave and a −SIN wave according to the integral value of the NCO 66, and output the waves to the complex multiplier 62. That is, the oscillator 65 generates a signal with a frequency corresponding to the detected symbol rate IFSYM.

The synchronization detector 68 determines from the output signal (the I signal and the Q signal) of the LPF 63, whether or not synchronization of the phase-locked loop 60 is established, i.e., whether nor not the detected symbol rate IFSYM has a constant value, and outputs the determination result to the control section 69 as a synchronization flag. For example, where the Q signal indicates 0, and the I signal has a value equal to or greater than a threshold value, the synchronization detector 68 determines that synchronization is established.

The sweep section 80 includes an adder 82, and a flip-flop 84 which can load a value. The control section 69 loads the maximum symbol rate FsymMAX to the flip-flop 84 using a start pulse from an external CPU as a trigger. The flip-flop 84 outputs the loaded maximum symbol rate FsymMAX as a swept frequency SWPF, and then delays and outputs an output from the adder 82. The adder 82 adds a constant value −ΔF to an output from the flip-flop 84. That is, the sweep section 80 repeatedly adds −ΔF to the maximum symbol rate FsymMAX, thereby reducing the swept frequency SWPF.

FIG. 5 is a graph illustrating examples of the detected symbol rate IFSYM and the swept frequency SWPF. For example, in the case where a digitally modulated signal DT having a symbol rate of Fsym is input to the symbol rate detector 22, the detected symbol rate IFSYM decreases in a manner similar to the swept frequency SWPF. When the detected symbol rate IFSYM reaches the symbol rate Fsym, the phase-locked loop 60 becomes locked and the detected symbol rate IFSYM becomes constant (IFSYM=Fsym). This is because, in the lock state, the loop filter 70 outputs a signal, of which frequency temporally increases, in order to cancel a temporal decrease in the output SWPF from the sweep section 80 at the output of the adder 64. That is, the LPF 63, which supplies an input signal to the loop filter 70, outputs a stationary phase error.

When the swept frequency SWPF reaches the minimum symbol rate FsymMIN, the sweep section 80 stops sweeping, and holds the swept frequency SWPF. At this time, since the temporal decrease in the swept frequency SWPF stops, the stationary phase error of the output of the LPF 63, which supplies the input signal to the loop filter 70, becomes 0 on average and the loop filter 70 is in a locked state. Then, the control section 69 monitors whether or not the synchronization detector 68 detects establishment of synchronization. When synchronization is established, the control section 69 grants permission for the variable-bandwidth filter 18 and the timing recovery circuit 24 to operate using the detected symbol rate IFSYM. Upon receipt of the permission, the variable-bandwidth filter 18 and the timing recovery circuit 24 start demodulation based on the detected symbol rate IFSYM.

As described above, in the symbol rate detector 22, the phase-locked loop 60 is in synchronization with the baseband signal DT, the symbol rate IFSYM of the baseband signal DT can be detected without using FFT. Since there is no need to perform FFT, a memory for the FFT is not required, and a large increase in a circuit scale can be mitigated even when the detection precision is improved. Also, since the sweep section 80 and the adder 64 are included, the symbol rate IFSYM can be rapidly obtained. Since the sweep section 80 stops the operation after sweeping a predetermined sweep range, there is no need to waste time for search.

As shown in FIG. 5, when the detected symbol rate IFSYM is locked at a constant value Fsym, an input signal to the loop filter 70 is in the state of having a stationary phase error. The synchronization detector 68 determines that synchronization is established when the phase error is within a specific range. For example, the synchronization detector 68 may determine that synchronization is established when an absolute value of the Q signal of an output from the LPF 63 is equal to or smaller than a threshold value, or the result obtained from Î2+Q̂2 or √(Î2+Q̂2) is equal to or greater than a threshold value. The reference character Q denotes a quadrature component of the output from the LPF 63, the reference character I denotes an in-phase component of the output from the LPF 63.

The control section 69 monitors the synchronization flag even during the sweep. When the synchronization detector 68 outputs the synchronization flag indicating that the synchronization is established, the control section 69 notifies the variable-bandwidth filter 18 and the timing recovery circuit 24 that the synchronization is established. This further reduces the search time.

The symbol rate at the start of sweep may begin with the frequency used most frequently. This further reduces the search time. Since a transmission rate is often increased to obtain high definition image quality, for example, as shown in FIG. 5, the sweep is performed from a higher frequency to a lower frequency where the frequency at the start of the sweep is the maximum symbol rate FsymMAX.

While the LPF 63 is configured to output the complex signal, it may be configured to output only the Q signal when the synchronization detector 68 detects only that the value of the Q signal is 0.

While the output signal of the LPF 63 is input to the loop filter 70, the Q signal output from the complex multiplier 62 may be directly input to the loop filter 70.

While an example has been described where the sweep section 80 decreases the swept frequency SWPF from the maximum symbol rate FsymMAX to the minimum symbol rate FsymMIN, it may increase the swept frequency SWPF from the minimum symbol rate FsymMIN to the maximum symbol rate FsymMAX.

The synchronization detector 68 may determine that the synchronization is established when a predetermined time has passed after the end of sweep by the sweep section 80.

According to the embodiment, since a symbol rate can be detected in a short time, the present disclosure is useful as a symbol rate detector and a receiver, etc.

The many features and advantages of the invention are apparent from the detailed specification and it is thus intended by the appended claims to cover all such features and advantages of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A symbol rate detector comprising:
a nonlinear processing section configured to perform nonlinear processing on a digitally modulated signal, and to output a processed signal; and
a phase-locked loop being in phase synchronization with the processed signal, wherein
the phase-locked loop includes
an oscillator configured to generate a signal with a frequency corresponding to a detected symbol rate,
a complex multiplier configured to multiply the processed signal by the signal generated by the oscillator, and to output a multiplication result, and
a loop filter configured to smooth the multiplication result, and to output the smoothed multiplication result as the detected symbol rate.

2. The symbol rate detector of claim 1, further comprising
a DC canceller configured to output the processed signal to the complex multiplier after reducing a direct-current component.

3. The symbol rate detector of claim 1, wherein
the nonlinear processing section performs as the nonlinear processing, a sum operation of a square of an in-phase component of the digitally modulated signal and a square of a quadrature component of the digitally modulated signal.

4. The symbol rate detector of claim 1, wherein
the phase-locked loop further includes
a sweep section configured to increase or decrease an output value of the sweep section, and
an adder configured to add the output value of the sweep section to the multiplication result smoothed by the loop filter, and to output an addition result as the detected symbol rate.

5. The symbol rate detector of claim 4, wherein
the phase-locked loop further includes a synchronization detector configured to determine that synchronization is established when an in-phase component of the multiplication result has a value equal to or greater than a threshold value.

6. The symbol rate detector of claim 4, wherein
the phase-locked loop further includes a synchronization detector configured to determine that synchronization is established when a predetermined time has passed after the end of sweep by the sweep section.

7. The symbol rate detector of claim 4, wherein
the phase-locked loop further includes a synchronization detector configured to determine that synchronization is established when a quadrature component of the multiplication result has a value equal to or smaller than a threshold value.

8. The symbol rate detector of claim 4, wherein
the phase-locked loop further includes a synchronization detector configured to determine that synchronization is established when a sum of a square of an in-phase component of the multiplication result and a square of a quadrature component of the multiplication result is equal to or greater than a threshold value.

9. A receiver for receiving a digitally modulated signal, the receiver comprising:
a symbol rate detector configured to detect a symbol rate of the digitally modulated signal from the digitally modulated signal; and
a variable-bandwidth filter configured to allow a component of the digitally modulated signal to pass, where the component is in a frequency range corresponding to the symbol rate detected by the symbol rate detector, wherein
the symbol rate detector includes
a nonlinear processing section configured to perform nonlinear processing on the digitally modulated signal, and to output a processed signal, and
a phase-locked loop being in phase synchronization with the processed signal, and
the phase-locked loop includes
an oscillator configured to generate a signal with a frequency corresponding to the detected symbol rate,
a complex multiplier configured to multiply the processed signal by the signal generated by the oscillator, and to output a multiplication result, and
a loop filter configured to smooth the multiplication result, and to output the smoothed multiplication result as the detected symbol rate.

10. The receiver of claim 9, further comprising:
an interpolation circuit configured to perform interpolation on an output from the variable-bandwidth filter based on a timing signal, and to output an interpolation result; and
a timing recovery circuit configured to generate the timing signal from an output from the interpolation circuit using the detected symbol rate.

11. The receiver of claim 10, further comprising:
a demodulation circuit configured to demodulate the output from the interpolation circuit, and to output obtained demodulated data; and
an error correction circuit configured to perform error correction on the demodulated data, and to output an error correction result.

12. The receiver of claim 9, further comprising
a quadrature demodulation circuit configured to perform quadrature demodulation on the digitally modulated signal, and to output a generated complex signal, wherein
the symbol rate detector detects the symbol rate from the complex signal.
